(19) United States
(12) Patent Application Publication
(10) Pub. No.: US 2010/0066854 A1
(43) Pub. Date: Mar. 18, 2010

(54) Camera and imaging system

(75) Inventors: Jonathan Mather, Oxford (GB); Andrew Kay, Oxford (GB); Harry Garth Walton, Oxford (GB)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/584,785

(22) Filed: Sep. 11, 2009

(30) Foreign Application Priority Data
Sep. 12, 2008 (GB) 0816698.5

(51) Int. Cl. H04N 5/228; G03B 17/00; H04N 5/335

(52) U.S. Cl. 348/222.1; 396/439; 348/294; 348/E05.091; 348/E05.031

(57) ABSTRACT

A camera comprises an imaging system having a first depth of field for one or more first colours and a second depth of field, smaller than the first depth of field, for one or more second colours. The imaging system may comprise an iris with a first aperture for the first colour or colours and a second aperture, which is larger than the first, for the second colour or colours. The first aperture may be defined by an outer opaque ring (1) and the second by an inner chromatic ring (2). The inner ring (2) blocks the first colour(s) and passes the second colour(s). The image formed of the first colour(s) is sharper and its sharpness may be transposed by image processing to the other images.

This Nonprovisional application claims priority under 35 U.S.C. §119(a) on UK Patent Application No. 0816698.5 filed in the United Kingdom on Sep. 12, 2008, the entire contents of which are hereby incorporated by reference.

### TECHNICAL FIELD

This invention relates to a camera and to an imaging system.

### BACKGROUND ART

A few years ago, cameras that were put into mobile phones tended to be small and low resolution. Small cameras can have a very high depth of field (meaning that a wide range of distances may be in focus at the same time). The depth of field was so high that a fixed focus lens could be used and this fixed focus lens was sufficient to focus on all desirable distances.

To increase the performance of today's camera phones, the cameras are larger and of higher resolution. Scaling a camera design to make it larger reduces its depth of field. The depth of field is such that a fixed focus lens cannot focus on a wide enough range of distances. Instead, mechanically movable lenses are used. These change position depending on how far away the object is so that it is brought into focus.

There are different types of movable lens systems. ‘Manual focus’ systems may be adjusted manually by the user, whereas ‘auto focus’ systems may be automatically moved by an electronic system. Manual systems undesirably require input from the user whereas auto focus systems are expensive and there is a delay whilst such systems focus. Neither types of system can focus on all distances simultaneously.

There is a need for a camera system that does not require a moving lens to focus on an object. This has been achieved to some extent by the prior art.

One such system is described in the paper CATHEY, W., AND DOWSKI, R. 1995. A new paradigm for imaging systems. Applied Optics 41, 1859.1866. This paper describes the design of a lens system which has useful focussing properties. A standard lens system has a sharp focus, and outside of this focal distance the image becomes rapidly more blurry. The lens system described in this paper does not have a sharp focus. Instead, it has a wide range of focal distances in which the image is blurred by a similar amount. By using image processing it is possible (using standard deconvolution or sharpening techniques) to de-blur the image within this range of focal distances since the lens has blurred the image by a known amount.

Although this system may be effective, it may be difficult to restore an image to the quality level achieved by a sharp focusing lens by image processing. It may be that the image is always of medium quality rather than good quality.

Another camera system is described by company DxO in WO/2006/095110. This publication describes a camera system with huge axial chromatic aberration. Red light is brought to focus for objects far away, green light is brought to focus for objects at a medium distance away, and blue light is brought to focus for objects that are close. DxO then use image processing to determine which colour channel is the sharpest, and then transpose the sharpness of the sharpest colour channel to the other colour channels which are out of focus. However, whatever the object distance, the image always needs processing. This may be slow and may result in lower quality images than normal.

Another well known method for increasing depth of field is to reduce the aperture of the lens. This increases depth of field, but it reduces the light sensitivity of the system at the same time.

### SUMMARY OF INVENTION

According to a first aspect of the invention, there is provided a camera comprising an imaging system having a first depth of field for at least one first frequency of optical radiation and a second depth of field, smaller than the first depth of field, for at least one second frequency of optical radiation.

The at least one first frequency may comprise at least one first colour. The at least one first colour may comprise at least one first primary colour.

The at least one first frequency may comprise at least one first invisible frequency.

The at least one first frequency may comprise at least one first frequency band.

The at least one second frequency may comprise at least one second colour. The at least one second colour may comprise at least one second primary colour.

The at least one second frequency may comprise at least one second frequency band.

The imaging system may comprise a wavecoding element for providing the first depth of field for the at least one first frequency of optical radiation.

The imaging system may comprise a coded aperture for providing the first depth of field for the at least one first frequency of optical radiation.

The imaging system may comprise a chromatic aperture for providing the first depth of field for the at least one first frequency of optical radiation.

The imaging system may comprise a combination of a coded aperture and a chromatic aperture.

The chromatic aperture may comprise an iris having a first aperture for the at least one first frequency of optical radiation and a second aperture, larger than the first aperture, for the at least one second frequency of optical radiation. The iris may comprise an outer iris defining the second aperture and an inner iris defining the first aperture. The inner iris may comprise an optical filter for substantially blocking the at least one first frequency and for passing the at least one second frequency.

The inner iris may provide an attenuation to the at least one first frequency which is an increasing function of the brightness of incident radiation.

The inner iris may comprise a light reactive dye.

At least one of the inner and outer irises may be apodised.

The first aperture may have an area substantially equal to half the area of the second aperture.

The imaging system may comprise an apodised chromatic aperture for providing the first depth of field for the at least one first frequency of optical radiation.

The camera may comprise an image sensor having at least one first array of sensor elements responsive to the at least one first frequency and at least one second array of sensor elements responsive to the at least one second frequency.

The camera may comprise an image processor for processing images at the first and second frequencies to provide a colour image having a depth of field greater than the second depth of field.

The processor may be arranged to transpose the sharpness of the or each image at the at least one first frequency onto the or each image at the at least one second frequency.

The processor may be arranged to form a luminance image from at least the or each image at the at least one second frequency and to transpose the sharpness of the or each image at the at least one first frequency onto the luminance image.

The processor may be arranged to form a luminance image from the or each image at the at least one first frequency.

The processor may be arranged to de-blurr the or each image at the at least one first frequency.

The processor may be arranged to determine object distances in the images and to process only foreground object image data.

According to a second aspect of the invention, there is provided an imaging system comprising an iris having an inner portion defining a first aperture and an outer portion defining a second aperture larger than the first aperture, the inner portion being made of a material which reacts to the brightness of incident radiation such that the inner portion has a first attenuation to incident radiation in response to a first brightness and a second attenuation, greater than the first attenuation in response to a second brightness greater than the first brightness.

According to a third aspect of the invention, this is provided a camera comprising an imaging system according to the second aspect of the invention.

According to a fourth aspect of the invention, there is provided a camera comprising a sensor and an imaging system for forming an image on the sensor, the sensor having a first set of sensing elements sensitive to a first frequency band of optical radiation and a second set of sensing elements sensitive to a second frequency band of optical radiation different from the first frequency band, the imaging system having an aperture with a first region arranged to pass at least optical radiation in the first frequency band and substantially to block optical radiation in the second frequency band and a second region arranged to pass at least optical radiation in the second frequency band.

The second region may be arranged substantially to block optical radiation in the first frequency band.

At least one of the first and second frequency bands may be in the visible light frequency band.

The first and second frequency bands may be non-overlapping.

The aperture may have a third region having a different frequency passband from the first and second regions.

The third region may be arranged to pass optical radiation in at least the first and second frequency bands.

The third region may be arranged to pass optical radiation in a third frequency band and substantially to block optical radiation in the first and second frequency bands and the first and second regions may be arranged to pass optical radiation in the third frequency band.

The camera may comprise an image processor arranged to determine disparity between at least part of the images sensed by the first and second sets of sensing elements. The image processor may be arranged to determine object distance from the camera from the disparity. The image processor may be arranged to perform image deblurring based on the object distance.

The camera may comprise a personal digital assistant or a mobile telephone.

The term “optical radiation” as used herein is defined to mean electromagnetic radiation which is susceptible to optical processing, such as reflection and/or refraction and/or diffraction, by optical elements, such as lenses, prisms, mirrors and holograms, and includes visible light, infrared radiation and ultraviolet radiation.

It is thus possible to provide a camera which is capable of providing large depth of field without requiring a moveable lens system. It is not necessary to provide manual or auto focus systems so that moving parts associated with mechanical focusing may be avoided, as may delays resulting from focusing. Such cameras are suitable for use in mobile (or “cellular”) telephones of larger size for providing higher resolution.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a diagrammatic front view of an iris forming part of an imaging system of a camera constituting an embodiment of the invention;

FIG. 2 is a diagrammatic cross-sectional view of part of a camera constituting an embodiment of the invention;

FIG. 3a is a diagram illustrating an optical system for use in a camera constituting an embodiment of the invention;

FIG. 3b is a diagrammatic cross-sectional view of a camera including the optical system of FIG. 3a;

FIGS. 4a to 4d are diagrams illustrating other optical systems which may be used in a camera of the type shown in FIG. 3b;

FIG. 5 is a diagram illustrating a camera constituting an embodiment of the invention; and

FIG. 6 is a diagram illustrating an image sensor of the camera shown in FIG. 5.

### DESCRIPTION OF EMBODIMENTS

As mentioned before, reducing the aperture of a camera system increases its depth of field. In the embodiments described hereinbefore, the aperture of the camera is reduced for one colour channel (or possibly more but not all). This means that one colour channel has a high depth of field and, by use of image processing, the sharpness from this channel is transposed to the other colour channels. By this method, the camera system can produce high resolution sharp images of a wide range of focal distances. Moreover, the sensitivity of the camera is not significantly affected because the size of the aperture is only reduced for one of the colour channels. By only reducing light levels in one colour channel, the total light input of the system may only be reduced by 10%, for example.

Such a system uses a ‘chromatic aperture’ comprising an iris, an example of which is shown in FIG. 1. A standard aperture comprises a black or opaque ring, which may for example be made of a plastics material and which allows all colours of light to pass through its centre. The new aperture comprises an opaque aperture ring 1 forming an outer iris with a smaller colour or chromatic aperture ring 2 forming an inner iris inside defining a clear aperture region 3. In this example, the aperture is reduced for the blue colour channel and the smaller colour ring 2 is made from a yellow colour filter. The yellow colour filter allows red and green light to pass through it with little or not attenuation, but blocks substantially completely blue light. So, the red light is blocked by the black ring 1 but passes through the yellow colour filter 2. Effectively, to red light, the aperture is defined by the black ring 1. The same is true for green light. The blue light is blocked by the black ring 1 and the yellow colour filter ring 2. The aperture for the blue light is defined by the yellow colour filter 2. The blue light “sees” a smaller aperture 3 than the red and green light.

The size of the smaller (first) aperture for the “sharp” colour channel is a compromise. If the aperture is big, more light is allowed to pass. This increases the light sensitivity and the light suffers less from diffraction (diffraction can blur the image), but the depth of field is reduced. If the aperture is small, less light is allowed to pass. This decreases the light sensitivity and the light suffers more from diffraction which would blur the image, but the depth of field is increased. In a typical application, a “sensible” compromise may be to reduce the aperture to about ⅔ of the size of the (second) aperture for the other colour channels. This results in about a 50% reduction in light throughput but a significantly increased depth of field. Other design values may be chosen to optimise between the various factors. For example, the first aperture may have an area substantially equal to half that of the second aperture.

Since the sharp colour channel is dimmer than the other channels, it may be appropriate to compensate for this by doing any of the following for the sharp channel: increasing the exposure time; increasing the gain; increasing the intensity by scaling the brightness using image processing. Also, for example in the case where the blue channel has reduced light sensitivity, the image may be illuminated with an increased level of blue light, for example by use of a camera flash that contains more blue light than usual.

The blue channel may be used as the sharp channel since blue light suffers less from diffraction. Also, since the eye is least sensitive to blue light, loss of information in the blue channel may be of least significance. As an alternative, the green channel may be used as the sharp channel since green provides most of the luminance information in an image and a sharp luminance channel may be important for good image quality. It is also possible to use the red colour channel as the sharp channel. Any combination of channels may be used as multiple sharp channels, for example red and blue. For each case, it is sufficient to provide a chromatic aperture which substantially blocks only light of the colour or colours of the sharp channel or channels.

This may be generalised to any set of colours that are detected by the sensor. For example, if the sensor senses two different green colours, one of the greens may be a sharp channel, depending on the choice of filter in the chromatic aperture. The chromatic aperture may be multicoloured so that each channel sees a different aperture.

The blur created by diffraction at an aperture is controlled to some extent by the transmission profile of the aperture. If the aperture changes from transmissive to non-transmissive sharply, then one diffraction pattern is created whereas, if the transition is smoothly varying (apodised), then a smoother diffraction pattern is created. It may be preferable to apodise the apertures to control the diffraction pattern that is created. This may be particularly useful if software is used to de-blur the diffraction in the sharp channel, since the apodisation may make the diffraction blur more constant with object distance.

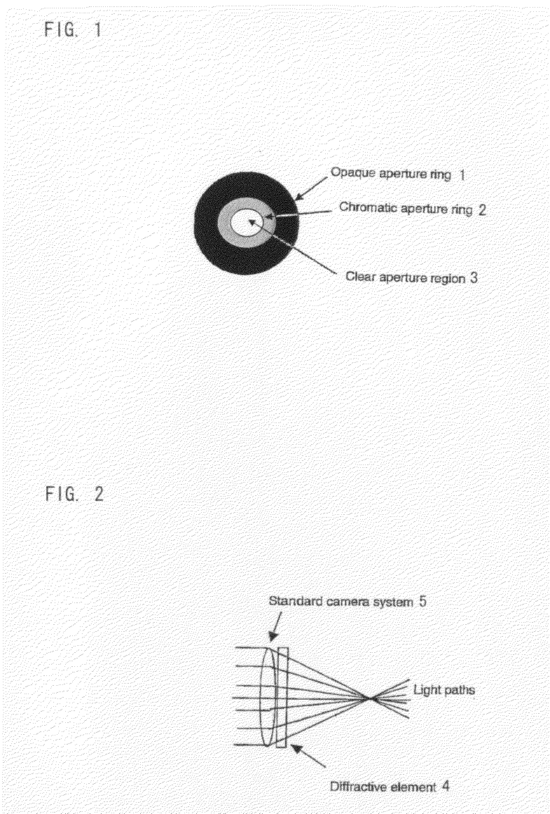

FIG. 2 shows an additional element 4 in front of a simple lens forming part of a standard camera system 5. This is a simplified diagram since a good quality camera lens typically comprises many carefully designed lens elements. Additional elements (such as the chromatic aperture) would need to be incorporated into a good quality camera lens system for optimum effect. This would be possible by those skilled in this art.

Once one colour channel is made sharp by use of a chromatic aperture, then the other channels may be sharpened by image processing. The following describes various techniques which are suitable for this.

One such method of image processing would be to try to create a sharp luminance channel from the data, as follows.

The human visual system is much better at perceiving sharpness in luminance (brightness) than chrominance (colour). Chrominance channels can be quite blurred without observable degradation in perceived sharpness. Therefore, sharpening of the image may be performed by constructing a sharp luminance channel from existing three-channel data. In JPEG conversion, the luminance (Y) channel is a blend of the red, green and blue channels with 29.9% red, 58.7% green and 11.4% blue.

If the blue is used as the sharp channel, it may be possible to improve sharpness by increasing the amount of blue in the luminance. When the blue channel is just transposed to luminance, the resulting image appears almost as sharp as the blue channel on its own. However, if there is too much blue in the blend, the output will be noticeably different and look unnatural. It may be that a smaller increase in the amount of blue improves sharpness while causing an acceptably small change in appearance.

Because of the low proportion of blue in the luminance calculation (11.4%), it is difficult to obtain a natural-looking image out of the blue channel. An alternative technique for image processing uses the green channel as the sharp channel which accounts for 58.7% of luminance.

In this case it may be considered that the image is sufficiently sharp even without any image processing. The sharp channel is simply set to be the green channel by the chromatic aperture and the sharpness from the green channel should naturally dominate the image.

Another method of image processing to increase the sharpness assumes that there is some kind of a de-blurring operation whose strength may be varied. In normal use (without the information from a sharp colour channel), this strength would have to be a compromise between desirable sharpness and undesirable enhancement of noise.

In this method, a high-pass filtered sharp channel is blurred by an amount similar to the blur in non-sharp colour channels. The resulting filtered image shows the location of high-frequency components such as edges and other detail in the image. This edge map is then used to vary the strength of the de-blur across the image. Areas with high frequency components such as edges and detail in the sharp channel can now be sharpened by a larger amount than areas without sharp edges.

In order to achieve improved sharpness, the algorithm may account for the relative position of the colour sub pixels. If this is not the case, the individual colour channels may be offset by half a pixel. When applying the filter, this offset should be accounted for so that the sharpening is done at the correct position.

The sharpness may be copied from the “sharp” channel to another channel using any of the methods disclosed by DxO in WO/2006/095110, the contents of which are incorporated herein by reference.

Any of the image processing methods may be combined for maximal effect.

When transferring sharpness from one channel to another, it may be necessary to correct for axial and lateral chromatic aberrations of the lens. These aberrations may cause the different colour channels to be scaled slightly differently to each other which may reduce the effectiveness of a sharpening algorithm. Methods for correcting for these aberrations are well known in the prior art.

It may be beneficial to de-blur the sharp channel. For instance the sharp channel may suffer a little from diffraction blurring. This slight blurring may be reduced by image processing before the sharpness is transferred to the other channels. This may be done by deconvolving the sharp channel image with the blur known to occur from diffraction in the lens system.

It may be best always to transfer the sharpness from the sharp channel to the other channels. As an alternative, the sharpness of the sharp channel may be transposed only if it is sharper than the other channels. As a further alternative, the sharp channel may be transposed if the ‘non-sharp’ channels are sufficiently blurred, without reference to the sharpness of the sharp channel.

When assessing the sharpness of the channels, an algorithm may look only at a central region or at one or more regions in the image, or it may look at the whole image or only at faces in the image. As an alternative, the assessment of sharpness may be made for each region in the image.

The processing stage may estimate distance to the objects in the scene by measuring the amount of blur in one of the ‘non-sharp’ channels and optionally comparing with the amount of blur in the sharp channel. The estimate may be used to select suitable parameters for de-blurring at least one of the channels. Such parameters may include choice of kernel for deconvolution, or shape and strength of function for a sharpening algorithm, or other method.

Any standard sharpening or de-blurring method may be used to de-blur any of the channels, possibly in addition to any other processing described herein. Standard methods may include sharpening using an unsharp mask, or a hardlight algorithm, or a constrained optimisation method, or any other as will be well known to those skilled in the art of image processing.

A ‘non-sharp’ channel may be combined with the sharp channel so as to calculate a kernel which can then be used to de-blur the ‘non-sharp’ channel in at least one part of the image. Such a kernel may be approximated by deconvolving the ‘non-sharp’ channels with the sharp channel (or vice versa), optionally filtering at least one of the channels first.

It may be advantageous to use information in the ‘non-sharp’ channels, which have more light and therefore a potentially higher signal-to-noise ratio, to denoise the sharp channel.

In addition, by measuring the distance of each part of the image to the camera as described above, it may be possible to distinguish between foreground and background. This may be useful for artistic portraits (for example) where the background is stripped from the portrait and replaced with a different background.

This technique may be used to read bar codes or scan text or business cards using data from the one or more sharp channels rather than full colour data. Possibly the non-sharp channels may be used for removing noise in this application.

Such a system has advantages over standard auto focus lenses in that there is no focus delay, and the expensive mechanics required to move the lens are not needed. In addition, such a system allows a large depth of field to be in focus at the same time whereas an auto focus system can focus on only one main object in the scene.

Such a system also has advantages over other extended depth of field systems such as the wavefront coding systems. As explained previously, such known systems require image processing to sharpen the image no matter what distance the object was away from the camera. The use of image processing to create a sharp image is generally less effective than use of good in-focus optics initially. All three colour channels may be made in-focus for medium and far distances, such that no image processing is required. In this way, excellent results are attained for the most popular photography including portraits and landscapes. The image processing may only be needed to sharpen near images. These near images may be of slightly reduced quality but this is often of lesser importance.

In addition, for reading monochrome bar codes at close distance, it is likely that no image processing is needed because the data may be read directly from the sharp channel. Other systems would need to record and process the image before the barcode can be read, which may cause unwanted delay.

Cameras of this type may comprise or be formed in personal digital assistants, mobile telephones or the like.

### Embodiment 1

FIG. 1 is a diagram of embodiment 1. In this embodiment, a chromatic aperture is used to make the aperture of the lens smaller for the blue channel and therefore increase the depth of field in the blue channel. The sharpness of the blue channel is then transposed from the blue channel to the other colour channels by image processing. The gain of the blue channel is increased to compensate for the reduced light input in the blue channel.

The camera thus has an imaging system with a first depth of field for at least one first frequency of optical radiation, such as at least one first frequency band (blue) and a second smaller depth of field for at least one second frequency of optical radiation, such as at least one second frequency band (red and green).

### Embodiment 2

FIG. 2 is a diagram of embodiment 2. The camera system contains an extra diffractive element 4 that only operates on one colour channel. The diffractive element acts as a wavecoding element and is designed to create a wavecoding effect as known in the prior art. That is to say, the element 4 creates a uniform blur of objects over a wide range of distances such that the blur can be reversed, after the image is recorded, by image processing. The diffractive element 4 may be made to operate for only one colour channel by making it from an amplitude mask that is made from a colour filter material. For example, if a yellow colour filter is used, the diffractive element is substantially invisible to red and green light whilst still effective for blue light.

In this way, the camera lens operates as a standard lens for red and green channels, thereby giving excellent image quality at medium and far distances because only the blue channel suffers image processing. For the near distances, the blue channel is de-blurred by image processing and is sharper than the red and green channels whose depth of field is not good. The blue channel sharpness is then transposed to the red and green channels.

### Embodiment 3

The technique disclosed in “Image and Depth from a Conventional Camera with a Coded Aperture”, by Levin et al, ACM SIGGRAPH 2007 papers, article No. 70, 2007, discloses a ‘coded aperture’, which is compatible with the concept of having one specific high depth of field colour channel. This paper describes the use of a coded aperture which is an aperture with a special pattern. This pattern blocks certain frequency components of the image in a depth-dependant way. By identifying which frequency components of the image are missing from the image, the distance of an object may be judged and therefore the level of blur from the camera lens may be judged and reversed by image processing. The coded aperture need not be made from black and clear components as stated in the paper, but, in this embodiment, the coded region may be made from a chromatic dye. This would enable the de-blurring to be carried out on one colour channel and, once this sharp colour channel is created, the sharpness may be transferred to the other channels. In this way, only one colour channel suffers the effect of blocking certain frequency components from the image. For example, in the case of creating a sharp blue channel, the coded aperture region would be made from a yellow colour filter so that it only affects the blue colour channel.

### Embodiment 4

In another embodiment of the invention, the chromatic aperture reduces the aperture of a non-visible light channel such as infra-red or ultra-violet light. Therefore the non-visible channel has a large depth of field. The non-visible channel is detected by additional pixels in the sensor and the sharpness is transferred from the non-visible channel to the other colour channels.

### Embodiment 5

In another embodiment, the camera has an aperture which comprises a light reactive dye. For example, a portion of the aperture is made from this dye such that in bright lighting conditions the dye becomes dark; this reduces the aperture and increases depth of field. This light loss in this condition is not a problem for the sensor since there is plenty of light from the scene. In dark conditions where low light levels may cause a problem, the dye becomes clear which increases the aperture of the camera and increases the light sensitivity of the camera. This technique may be applied to a standard black and clear aperture or, in the case of a chromatic aperture for increased depth of field in the blue channel; the yellow colour filter may be made from a dye that changes from yellow to clear depending on the lighting conditions. Thus, the inner iris provides an attenuation to at least one first frequency of optical radiation which is an increasing function of the brightness of incident radiation. The inner iris (or inner portion of the iris) may be made of a material which reacts to the brightness of incident radiation such that the inner portion has a first attenuation to incident radiation in response to a first brightness and a second attenuation greater than the first in response to a second brightness greater than the first brightness.

### Embodiment 6

In another embodiment, a wavefront coding system (or other high depth of field lens design) is combined with a chromatic aperture. In this way, two colour channels use the wavefront coding technique to create a sharp image, whilst the third colour channel uses the wavefront coding and a reduced aperture. With the combination of the two technologies, it may be possible to make the third channel extremely sharp and therefore achieve better image quality. Alternatively, the combination may make the processing part more efficient, resulting in a cheaper or faster processing step.

### Embodiment 7

In another embodiment, the lens of the camera has high axial chromatic aberration such that each colour channel focuses on a different range of depths in the scene. This is like the technology used by DxO. In addition, the chromatic aperture is applied so that one of the colour channels may have an extended depth of field as well as a displaced focal range.

A combination of coded aperture and chromatic aperture may be used so that one channel has a reduced aperture for high depth of field and another colour channel has a coded aperture for easy de-blurring of the image.

Indeed, any combination of chromatic aperture, coded aperture, axial chromatically aberrated lens design, and wavefront coding designs may be used in conjunction with each other. Software may be used to combine the strengths of each design to create one high quality image.

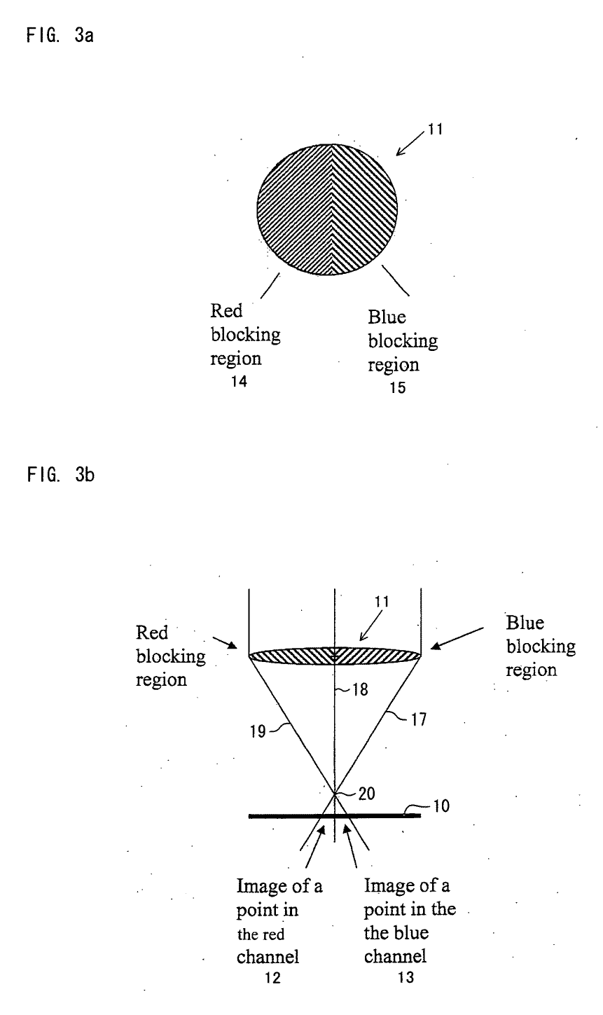

FIGS. 3a and 3b illustrate another type of camera comprising a sensor 10 and an Imaging system 11, which is illustrated as a single convex lens but which may be of any suitable type for forming an image on the sensor 10. The sensor 10 may be of any suitable type but typically comprises a charge coupled device sensor which is pixelated and comprises three or more sensing elements which are sensitive to different frequency bands of optical radiation, usually in the visible light frequency band. The sensing elements are arranged as arrays with elements of the different sets being interleaved with each other. In a typical example of such a sensor, there are three sets of sensing elements sensitive to red, green and blue light and referred to as “channels”. FIG. 3b indicates the imaging of a point in the red and blue channels at 12 and 13.

The imaging system has an aperture which is illustrated in FIG. 3a. In this embodiment, the aperture is divided into two semi-circular sub-apertures or “regions” 14 and 15. The first region 14 of the aperture is arranged to pass at least optical radiation in the first frequency band and to block optical radiation in the second frequency band, where first and second sets of sensing elements or channels respond to the first and second frequency bands. In this embodiment, the region 14 passes green and blue light but blocks red light.

The second region 15 is arranged to pass at least optical radiation in the second frequency band. In the example of FIG. 3a, the second region 15 blocks optical radiation in the first frequency band, so that the region 15 passes red and green light but blocks blue light. The first and second frequency bands, in this case red and blue light, are non-overlapping.

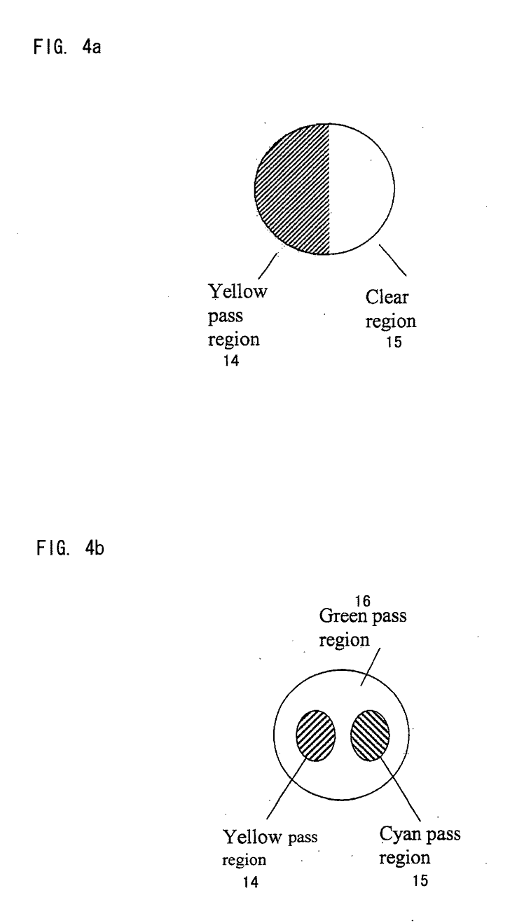

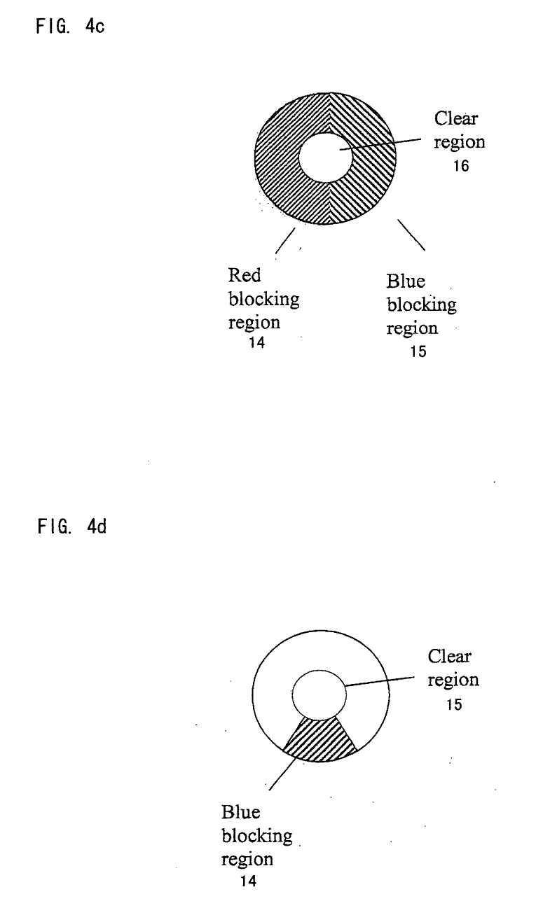

Examples of other apertures for use in this embodiment are illustrated in FIGS. 4a to 4d. In FIG. 4a, the first region (yellow pass region) 14 passes red and green light (yellow light) but blocks blue light whereas the second region (clear region) 15 is clear and passes the whole of the visible light spectrum. In the aperture of FIG. 4b, the first (yellow pass region) and second (cyan pass region) regions 14 and 15 are circular or elliptical and are surrounded by a third region (green pass region) 16. The first region 14 passes red and green light (yellow light) but blocks blue light, the second region 15 passes blue and green light (cyan light) but blocks red light, and the third region 16 passes green light but blocks red and blue light. Thus, the third region passes optical radiation in a third frequency band and substantially blocks optical radiation in the first and second frequency bands whereas the first and second regions are arranged to pass optical radiation in the third frequency band.

FIG. 4c illustrates another type of aperture which differs from that shown in FIG. 3a in that a clear circular third region (clear region) 16 is provided at the middle of the aperture and transmits red, green and blue light.

The aperture shown in FIG. 4d comprises a first blue blocking region 14 shaped as a portion or sector of an annulus. The second region (clear region) 15 comprises the remainder of the circular aperture and is clear, i.e. it transmits red, green and blue light.

The light ray paths 17, 18 and 19 shown in FIG. 3b are from an object on the optical axis of the imaging system and located “at infinity” such that the light rays from the object are incident substantially parallel to each other and to the optical axis. The image of the object is out of focus, as illustrated by the intersection of the ray paths 17, 18 and 19 at a point 20 in front of the sensor 10. Images of objects in the “red channel” 12 are displaced in position with respect to images of the same objects in the “blue channel” 13. The amount of relative displacement is called “disparity” and depends on the distance of an object from the camera. For example, for an object close to the camera, the red channel may be more displaced from the blue channel than for an object far from the camera. The direction of displacement depends on whether the object is in front of or behind the in-focus plane of the lens. Typically, different objects in a scene will be at different distances from the lens so the disparity will vary spatially in the image.

The disparity may be measured using any suitable image processing technique, many of which are well known in this field. One example of a suitable image processing technique is cross-correlation. Using this technique on regions of the captured image, the disparity between the object image in the red channel and in the blue channel may be found by estimating the image shift required to align the red and blue channel images.

Another technique which may be used to determine the disparity is phase correlation. A further suitable technique locates image features, such as edges or corners, in each image and matches them using standard vision processing methods in order to calculate the disparity. The distance of each object from the camera may therefore be determined. If the distance of an object from the camera is known, then further image processing techniques may be used to de-blur the image appropriately. For example, the amount and spatial distribution of blur produced by a camera lens at any particular object distance that is known, can be modelled, or can be measured by the camera designers. Because the disparity and hence the object distance can be calculated for each region of the image, the blur can be estimated for each region of the image. A standard technique known as deconvolution may then be used to convert the estimated blur in each region.

In another processing technique, the image may be de-blurred by searching through and applying a selection of de-blurring kernels based on the camera design until there is no longer any disparity between the red and blue channels. If the case of no disparity is achieved, then de-blurring has been successfully achieved.

Knowledge of the disparity and hence the distance of objects from the camera may be used for other purposes. For example, such knowledge may be used to produce a depth map of a scene and this may be used for applications such as three dimensional (3D) imaging or 3D sensing.

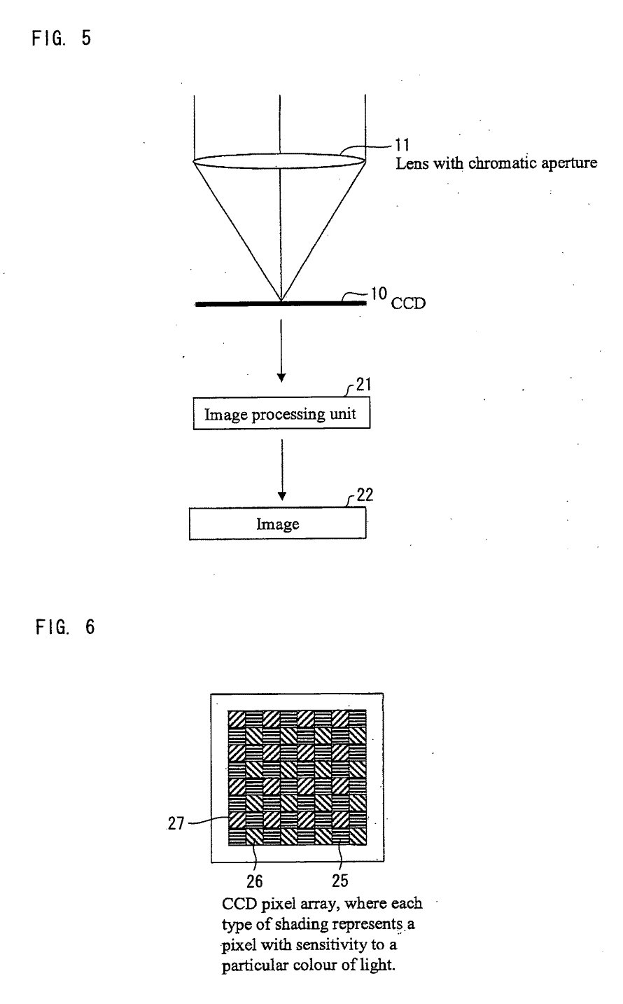

FIG. 5 illustrates a camera comprising a sensor 10 in the form of a charge coupled device (CCD) and an imaging system 11 illustrated as a lens with a chromatic aperture and comprising any of the arrangements described hereinbefore. The sensor 10 is connected to an image processing unit or processor 21, which processes the output of the sensor 10 to form one or more images 22.

FIG. 6 illustrates a front view of the sensor 10. The CCD pixels are arranged as an array with each type of shading in FIG. 6 representing a pixel with a sensitivity to a particular colour of light. For example, the pixels such as 25 may be sensitive to green light, the pixels such as 26 may be sensitive to red light and the pixels such as 27 may be sensitive to blue light. Thus, the pixels are arranged as first, second and third arrays of sensor elements responsive to respective frequencies of optical radiation, such as the respective primary colours.

The processor 21 may perform any or all of the processing described hereinbefore. Thus, the processor 21 may process images of the different frequencies or colours to provide a colour image having a depth of field greater than that provided by the iris aperture ring 1 for light which is passed by the chromatic aperture ring 2 in the arrangement of FIG. 1. For example, the processor may be arranged to transpose the sharpness of the or each image at the at least one first frequency (blocked by the chromatic aperture ring 2) onto the or each image at the at least one second frequency (passed by the chromatic aperture ring 2). As an alternative, the processor 21 may be arranged to form a luminance signal from the or each image at the at least one second frequency and to transpose the sharpness of the or each image at the at least one first frequency onto the luminance image.

In another alternative, the processor 21 is arranged to form a luminance image from the or each image at the least one first frequency.

The processor may be arranged to de-blur the or each image at the at least one first frequency. As an alternative, the processor may be arranged to determine the object distances in the images and to process only foreground image data. Alternatively or additionally, the processor 21 may provide disparity determination, distance determination, and/or de-blurring as described for the embodiments illustrated in FIGS. 3a to 4d.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A camera comprising an imaging system having a first depth of field for at least one first frequency of optical radiation and a second depth of field, smaller than the first depth of field, for at least one second frequency of optical radiation.

2. A camera as claimed in claim 1, in which the at least one first frequency comprises at least one first colour.

3. A camera as claimed in claim 2, in which the at least one first colour comprises at least one first primary colour.

4. A system as claimed in claim 1, in which the at least one first frequency comprises at least one first invisible frequency.

5. A camera as claimed in claim 1, in which the at least one first frequency comprises at least one first frequency band.

6. A camera as claimed in claim 1, in which the at least one second frequency comprises at least one second colour.

7. A camera as claimed in claim 6, in which the at least one second colour comprises at least one second primary colour.

8. A system as claimed in claim 1, in which the at least one second frequency comprises at least one second frequency band.

9. A camera as claimed in claim 1, in which the imaging system comprises a wavecoding element for providing the first depth of field for the at least one first frequency of optical radiation.

10. A camera as claimed in claim 1, in which the imaging system comprises a coded aperture for providing the first depth of field for the at least one first frequency of optical radiation.

11. A camera as claimed in claim 10, in which the coded aperture is made from a chromatic dye.

12. A camera as claimed in claim 1, in which the imaging system comprises a chromatic aperture for providing the first depth of field for the at least one first frequency of optical radiation.

13. A camera as claimed in claim 1, in which the imaging system comprises a combination of a coded aperture and a chromatic aperture.

14. A camera as claimed in claim 12, in which the chromatic aperture comprises an iris having a first aperture for the at least one first frequency of optical radiation and a second aperture, larger than the first aperture, for the at least one second frequency of optical radiation.

15. A camera as claimed in claim 14, in which the iris comprises an outer iris defining the second aperture and an inner iris defining the first aperture.

16. A camera as claimed in claim 15, in which the inner iris comprises an optical filter for substantially blocking the at least one first frequency and for passing the at least one second frequency.

17. A camera as claimed in claim 15, in which the inner iris provides an attenuation to the at least one first frequency which is an increasing function of the brightness of incident radiation.

18. A camera as claimed in claim 15, in which the inner iris comprises a light reactive dye.

19. A camera as claimed in claim 15, in which at least one of the inner and outer irises is apodised.

20. A camera as claimed in claim 14, in which the first aperture has an area substantially equal to half the area of the second aperture.

21. A camera as claimed in claim 1, in which the imaging system comprises an apodised chromatic aperture for providing the first depth of field for the at least one first frequency of optical radiation.

22. A camera as claimed in claim 1, comprising an image sensor having at least one first array of sensor elements responsive to the at least one first frequency and at least one second array of sensor elements responsive to the at least one second frequency.

23. A camera as claimed in claim 1, comprising an image processor for processing images at the first and second frequencies to provide a colour image having a depth of field greater than the second depth of field.

24. A camera as claimed in claim 23, in which the processor is arranged to transpose the sharpness of the or each image at the at least one first frequency onto the or each image at the at least one second frequency.

25. A camera as claimed in claim 23, in which the processor is arranged to form a luminance image from at least the or each image at the at least one second frequency and to transpose the sharpness of the or each image at the at least one first frequency onto the luminance image.

26. A camera as claimed in claim 23, in which the processor is arranged to form a luminance image from the or each image at the at least one first frequency.

27. A camera as claimed in claim 23, in which the processor is arranged to deblurr the or each image of the at least one first frequency.

28. A camera as claimed in claims 23, in which the processor is arranged to determine object distances in the images and to process only foreground object image data.

29. An imaging system comprising an iris having an inner portion defining a first aperture and an outer portion defining a second aperture larger than the first aperture, the inner portion being made of a material which reacts to the brightness of incident radiation such that the inner portion has a first attenuation to incident radiation in response to a first brightness and a second attenuation, greater than the first attenuation in response to a second brightness greater than the first brightness.

30. A camera comprising an imaging system as claimed in claim 29.

31. A camera comprising a sensor and an imaging system for forming an image on the sensor, the sensor having a first set of sensing elements sensitive to a first frequency band of optical radiation and a second set of sensing elements sensitive to a second frequency band of optical radiation different from the first frequency band, the imaging system having an aperture with a first region arranged to pass at least optical radiation in the first frequency band and substantially to block optical radiation in the second frequency band and a second region arranged to pass at least optical radiation in the second frequency band.

32. A camera as claimed in claim 31, in which the second region is arranged substantially to block optical radiation in the first frequency band.

33. A camera as claimed in claim 31, in which at least one of the first and second frequency bands is in the visible light frequency band.

34. A camera as claimed in claim 31, in which the first and second frequency bands are non-overlapping.

35. A camera as claimed in claim 31, in which the aperture has a third region having a different frequency passband from the first and second regions.

36. A camera as claimed in claim 35, in which the third region is arranged to pass optical radiation in at least the first and second frequency bands.

37. A camera as claimed in claim 35, in which the third region is arranged to pass optical radiation in a third frequency band and substantially to block optical radiation in the first and second frequency bands and the first and second regions are arranged to pass optical radiation in the third frequency band.

38. A camera as claimed in claim 31, comprising an image processor arranged to determine disparity between at least part of the images sensed by the first and second sets of sensing elements.

39. A camera as claimed in claim 38, in which the image processor is arranged to determine object distance from the camera from the disparity.

40. A camera as claimed in claim 39, in which the image processor is arranged to perform image deblurring based on the object distance.

41. A camera as claimed in claim 1, comprising a personal digital assistant or a mobile telephone.

42. A camera as claimed in claim 30, comprising a personal digital assistant or a mobile telephone.

43. A camera as claimed in claim 31, comprising a personal digital assistant or a mobile telephone.
